(19) United States
(12) Patent Application Publication
(10) Pub. No.: US 2025/0385586 A1
(43) Pub. Date: Dec. 18, 2025

(54) Vibration Motor

(71) Applicant: AAC Microtech (Changzhou) Co., Ltd., Changzhou City (CN)

(72) Inventors: Peng Cai, Changzhou (CN); Junsheng Wang, Changzhou (CN); Jie Wu, Changzhou (CN); Fali Zhong, Changzhou (CN)

(21) Appl. No.: 19/015,686

(22) Filed: Jan. 10, 2025

Related U.S. Application Data
(63) Continuation of application No. PCT/CN2024/099723, filed on Jun. 18, 2024.

(51) Int. Cl. H02K 33/18

(52) U.S. Cl. CPC H02K 33/18

(57) ABSTRACT

The vibration motor of the present invention includes a housing, a vibration unit, a driving unit, and a guide component. The vibration unit includes a magnet component having at least two magnets. The driving unit includes a coil component. The vibration motor further includes two auxiliary magnet components. Each auxiliary magnet component is magnetized along a second direction perpendicular to the first direction and forms a magnetic repulsion force with the corresponding first magnet. The vibration motor of the present invention has high reliability and long service life.

### TECHNICAL FIELD

This invention relates to the field of motor technology, particularly to a linear vibration motor.

### BACKGROUND

With the development of science and technology and the progress of society, portable electronic products, such as mobile phones, handheld game consoles, navigation devices, or handheld multimedia entertainment devices, are widely used in people's daily lives. In some usage scenarios of these electronic products, such as incoming call alerts, message notifications, navigation prompts, and gaming console vibration feedback, they are generally implemented through vibration motors.

The vibration motor of the related technology includes a vibration unit and a driving unit. Generally, the vibration unit is clamped by an elastic component and is provided with elastic restoring force by the elastic component, finally producing reciprocating motion. However, the elastic component undergoes deformation stress during the motion process, and the larger the motion stroke, the greater the stress. When the stress reaches the limit of the material's spring life, it will cause the elastic component to fracture, thereby leading to the failure of the vibration system.

Therefore, it is necessary to provide an improved vibration motor to solve the above problems.

### SUMMARY

One major purpose of the present invention is to provide a vibration motor, in which the repulsive force between the like poles of magnet is used as the force generated by the magnetic spring structure to solve the problems of small vibration amount and short lifespan of traditional elastic components.

To achieve the above purpose, the present invention provides a vibration motor comprising: a housing with a containment space; a vibration unit housed in the containment space, including at least two magnets arranged along a first direction with magnetization directions opposite to each other, and a coil component surrounding adjacent ends of the at least two magnets; a driving unit for driving the vibration unit to reciprocate along the first direction; a guide component supporting the vibration unit in the containment space; and two auxiliary magnet components fixed to the housing and respectively located at the two ends of the at least two magnets. Each auxiliary magnet component is magnetized along a second direction perpendicular to the first direction, for forming magnetic repulsion with the corresponding at least two magnets.

In addition, each auxiliary magnet component includes a pair of auxiliary magnets magnetized along the second direction and arranged on opposite sides of the vibration unit, for forming a magnetic repulsion with the corresponding at least two magnets.

Or each auxiliary magnet component includes two pairs of auxiliary magnets magnetized along the second direction and arranged on opposite sides of the vibration unit, for forming a magnetic repulsion with the corresponding at least two magnets.

Or each auxiliary magnet component is an annular magnet, with the second direction being the radial direction of the annular magnet, for forming a magnetic repulsion with the corresponding at least two magnet.

In addition, the guiding member comprises two guiding sleeves arranged along the first direction at two ends of the vibration unit; the guiding sleeves include guiding passages therethrough; the vibration unit is accommodated in the guiding passage and slidably connected to the guiding sleeves.

In addition, the vibration unit further includes a clamp plate located in the guiding sleeve and having a cavity; the magnet component is fixed with the clamp plate and accommodated in the cavity; and the clamp plate is slidably connected to the guiding sleeve.

In addition, the guiding sleeve further includes an avoidance groove for avoiding the edge of the clamp plate.

In addition, the magnet component further comprises a plurality of soft magnetic materials arranged at intervals along the first direction; an amount of the soft magnetic materials is 1 greater than an amount of the magnets; and the magnets are respectively disposed between two adjacent soft magnetic materials.

In addition, the vibration unit further comprises weights disposed at two ends of the magnet component; the soft magnetic material includes a first soft magnetic material sandwiched between the weight and the magnet component, and a second soft magnetic material clamped between adjacent magnets; the auxiliary magnet component spaces apart from the first soft magnetic material; and the coil component spaces apart from the second soft magnetic material.

In addition, the weight includes a first part positioned outside the cavity and a second part accommodated inside the cavity; the first part does not contact the guiding sleeve, the clamp plate abuts against the first part; the second part includes a groove on a surface connected to the clamp plate, and the groove engages with a protrusion on the clamp plate.

In addition, the soft magnetic material is made of at least one material selected from carbon steel, iron-cobalt alloy, amorphous alloy, and nanocrystalline alloys.

The new vibration motor of the present invention includes a housing with a containment space, a vibration unit accommodated in the containment space, a driving unit driving the vibration unit to reciprocate along a first direction, and a guiding member supporting the vibration unit. The vibration unit includes a magnet component arranged along the first direction, consisting of at least two magnets arranged along the first direction with magnetization in opposite directions between adjacent magnets. The driving unit includes a coil component set around the adjacent ends of the two magnets.

The vibration motor also includes two auxiliary magnet components fixed to the housing and respectively set at the two ends of the magnet component, which are defined as the first magnet. The two auxiliary magnet components are correspondingly arranged with the two first magnets, magnetized along a second direction perpendicular to the first direction to generate magnetic repulsion with the corresponding first magnet.

By using the magnetic repulsion generated by the auxiliary magnet components and the first magnet instead of traditional elastic components to provide restoring force to the vibration unit, the space occupied by traditional elastic components is saved, allowing for greater vibration displacement, effectively improving vibration performance and haptic effects, avoiding the shortening of service life due to issues like fatigue of traditional elastic components, and enhancing reliability.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of a vibration motor in accordance with an exemplary embodiment of the present invention.

FIG. 2 is an exploded view of the vibration motor in FIG. 1.

FIG. 3 is a partially-exploded view of the vibration motor in FIG. 1.

FIG. 4 is an partially-exploded view of a vibration unit of the vibration motor of the embodiment.

FIG. 5 is a cross-sectional view of the vibration motor taken along line A-A in FIG. 1.

FIG. 6 is a cross-sectional view of the vibration motor taken along line B-B in FIG. 1.

### DETAILED DESCRIPTION OF THE EMBODIMENTS

The following will be taken in conjunction with the accompanying drawings of embodiments of the present invention, The technical scheme in the embodiment of the invention is clearly and completely described. Obviously, the described embodiments are merely part of the embodiments of the present invention, and not all embodiments are based on the embodiments of the present invention, and all other embodiments attained by those of ordinary skill in the art without inventive effort are within the scope of the present invention.

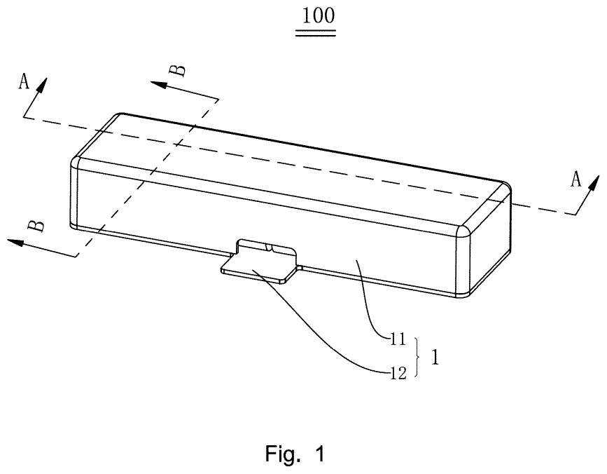

Please refer to FIGS. 1-6. This embodiment of the present invention provides a vibration motor 100, comprising a housing 1 with a containment space 10, a vibration unit 2 housed in the containment space 10, a driving unit 3 driving the vibration unit 2 to reciprocate along a first direction, and a guiding member 4 supporting the vibration unit 2. The housing 1 includes an upper cover 11 and a lower cover 12 coupled to the upper cover 11.

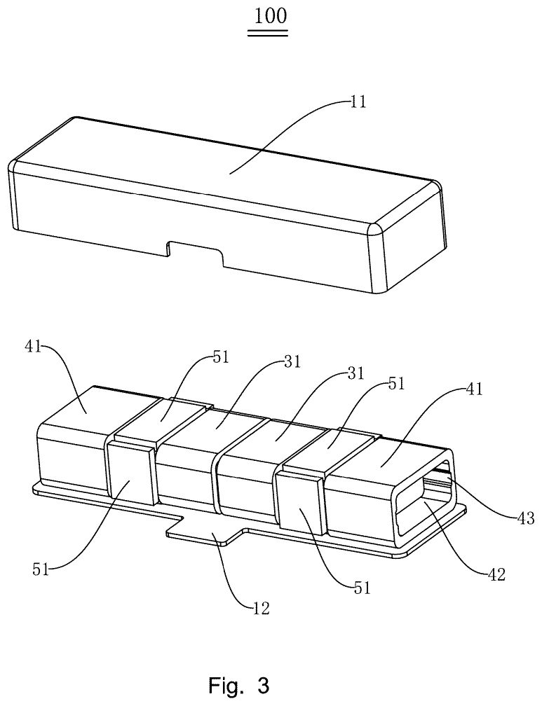

As shown in FIGS. 3-5, the vibration unit 2 includes a magnet component 21 arranged along the first direction, where the magnet component 21 comprises at least two magnets 211 arranged along the first direction. Each magnet 211 is magnetized along the first direction, with the magnetization direction of adjacent two magnets 211 being opposite to each other. When adjacent two magnets 211 of the same polarity are set opposite to each other, a strong magnetic field can be generated, thereby increasing the driving force.

The drive unit 3 includes a coil component 31 positioned around the adjacent ends of the two magnets 211. The vibration motor 100 also includes two auxiliary magnet components 5 fixed to the housing 1 and respectively set at the two ends of the magnet component 21. The magnets 211 arranged at the two ends are defined as the first magnet 2111. Each auxiliary magnet component 5 is magnetized along the second direction perpendicular to the first direction, forming a magnetic repulsion with the corresponding first magnet 2111. It should be noted that the second direction is a series of directions perpendicular to the first direction.

In the above structure, the magnetic repulsion force formed between the auxiliary magnet component 5 and the first magnet 2111 is used to replace traditional elastic components to provide restoring force for the vibration unit 2. This saves the space occupied by traditional elastic components, enabling greater displacement vibration, effectively improving vibration performance and vibration sensation, avoiding the shortcoming of using traditional elastic components due to fatigue issues, and enhancing the reliability of the vibration motor.

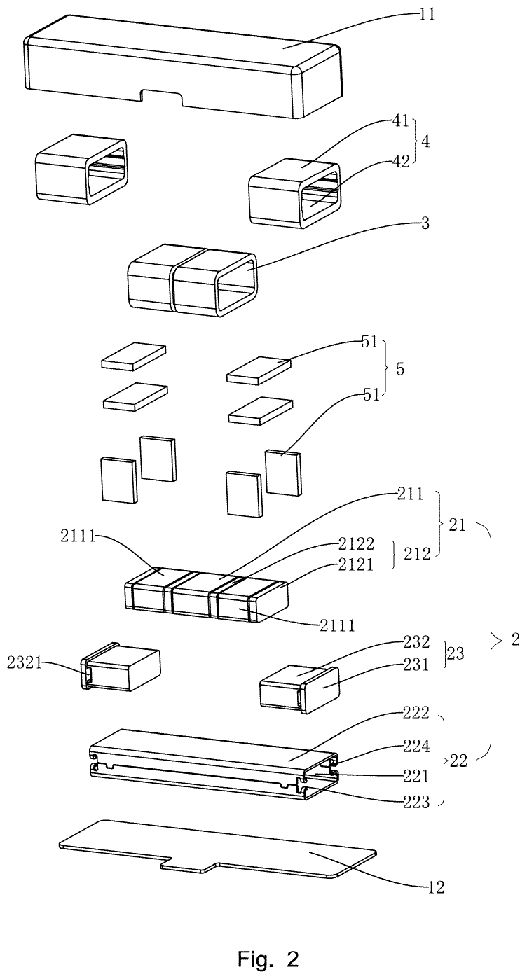

As shown in FIGS. 2-3, in this embodiment, each auxiliary magnet component 5 includes two pairs of auxiliary magnets 51 magnetized along the second direction and set on either side of the vibration unit 2, and the two pairs of auxiliary magnets 51 generate magnetic repulsion with the corresponding first magnet 2111. It should be understood that the second direction is a series of directions perpendicular to the first direction.

In another optional embodiment, each auxiliary magnet component 5 may also include a pair of auxiliary magnets 51 magnetized along the second direction and set on one side of the vibration unit 2, which generate magnetic repulsion with the corresponding first magnet 2111; or each auxiliary magnet component 5 can also be a circular magnet, with the second direction being radial for the circular magnet, and the circular magnet generates magnetic repulsion with the corresponding first magnet 2111.

Furthermore, as shown in FIG. 3, the guide component 4 includes two guiding sleeves 41 arranged along the first direction at the two ends of the vibration unit 2. The guiding sleeves 41 are provided with guide channels 42 passing through them. The vibration unit 2 is accommodated in the guide channels 42 and slidably connected to the guiding sleeves 41. Optionally, the guide component 4 can also be a sliding shaft inserted in the vibration unit 2, or the guide component 4 can be fixed to the housing 1 as a track, and so on, without limitation.

Furthermore, the vibration unit 2 includes a clamp plate 22 placed inside the guiding sleeve 41 with a cavity 221, the magnet component 21 is fixed on the clamp plate 22 and housed in the cavity 221, and the clamp plate 22 is slidably connected to the guiding sleeve 41. The magnet component 21 is set in the cavity 221. When the vibration unit 2 vibrates reciprocally in the guiding sleeve 41, the clamp plate 22 slides against the inner wall of the guiding sleeve 41, thereby protecting the magnet component 21 and avoiding damage to the magnet component 21 during movement. It should be noted that the clamp plate 22 can be integral or, as shown in this embodiment, formed by the upper clamp plate 222 and the lower clamp plate 223.

Furthermore, as shown in FIG. 6, the guiding sleeve 41 has an avoidance groove 411 for avoiding the edges of the avoidance plate 22. The edges of the upper clamping plate 222 and lower clamping plate 223 may have burrs, and the welding surfaces when the upper clamping plate 222 and lower clamping plate 223 are welded may be rough and uneven. The setting of the avoidance groove 411 can prevent these burrs and welding rough surfaces from increasing the sliding friction resistance between the vibration unit 2 and the guiding sleeve 41, thereby affecting the vibration effect of the vibration motor.

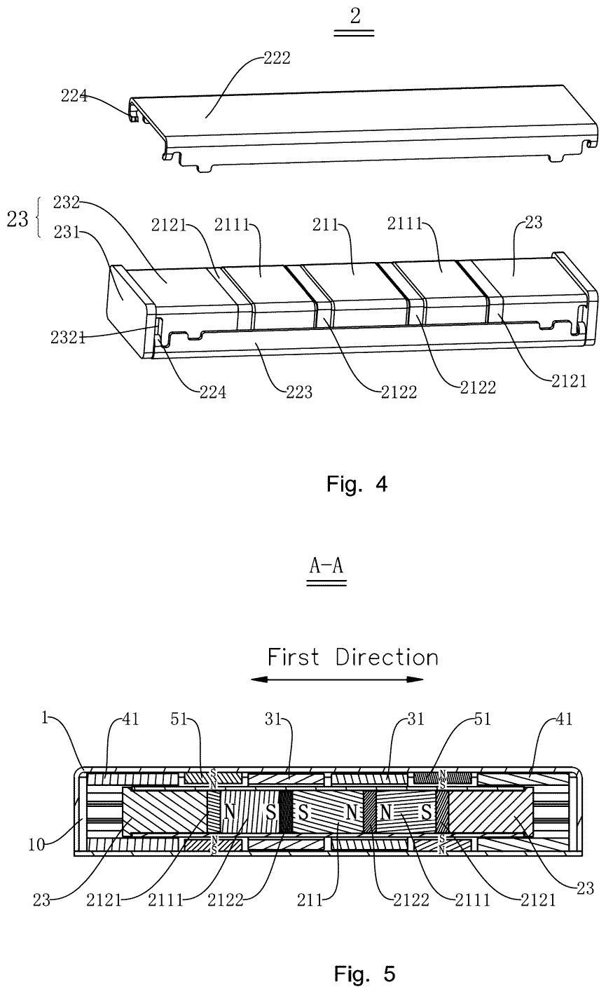

As shown in FIG. 4, the magnet component 21 further includes a number of soft magnetic materials 212 arranged at intervals along a first direction, with the quantity of soft magnetic materials 212 being one more than the quantity of magnets 211 and the magnets 211 being respectively set between adjacent two soft magnetic materials 212. The configuration of the soft magnetic materials 212 can enhance the magnetic field, thereby increasing the driving force of the vibration motor 100.

Furthermore, the vibration unit 2 also includes weights 23 set at both ends relative to the magnet component 21. The placement of weights 23 can provide a greater vibration amplitude. The soft magnetic material 212 includes the first soft magnetic material 2121 sandwiched between the weight 23 and the first magnet 2111, as well as the second soft magnetic material 2122 sandwiched between two adjacent magnets 211. The auxiliary magnet component 5 is spaced opposite the first soft magnetic material 2121, which allows for a more stable repulsive force between the auxiliary magnet component 5 and the first magnet 2111. The coil assembly 31 is spaced opposite the second soft magnetic material 2122, maximizing the use of the magnetic field to generate greater driving force.

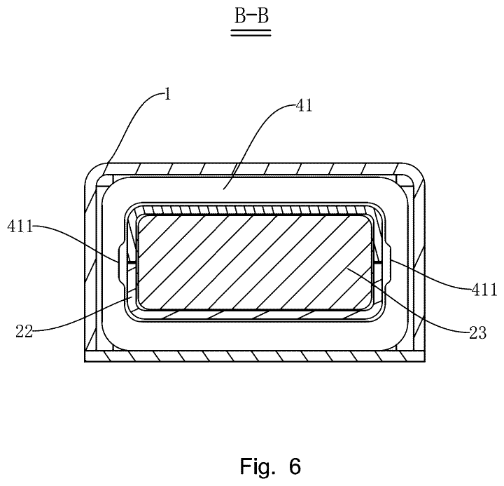

As shown in FIG. 5, the weight 23 includes a first part 231 located outside the cavity 221 and a second part 232 housed inside the cavity 221. The first part 231 does not come into contact with the guiding sleeve 41, and the clamp plate 22 abuts against the first part 231. When the vibration unit 2 reciprocates in the guiding sleeve 41, the arrangement of the first part 231 prevents the internal magnet component 21 and soft magnetic material 212 from being squeezed, deformed, or displaced by the weight 23, ensuring good vibration effects. The second part 232 also has grooves 2321 on the surface connected to the clamp plate 22, and the grooves 2321 are engaged with protrusions 224 set on the clamp plate 22 through a snap fit, making the assembly of the weight 23 and the clamp plate 22 more flexible and convenient. Additionally, during vibration, the snap fit prevents the weight 23 from separating from the clamp plate 22 due to inertia, ensuring good vibration stability.

Further, the soft magnet material 212 is made of soft magnetic materials, including carbon steel, iron-cobalt alloys, amorphous alloys, or nanocrystalline alloys. Of course, other high conductivity metals or alloys can also be used as soft magnetic materials, with no limitation here.

In this embodiment, the magnet component 21 is magnetized separately and then bonded and fixed to the soft magnetic material. To simplify assembly process and improve production efficiency, the magnet component 21 can also magnetize different regions of a whole piece of soft magnetic material as a whole.

Compared with related technologies, this invention uses the repulsive force formed between the auxiliary magnet component and the first magnet instead of traditional elastic components to provide restoring force for the vibration unit, saving the space occupied by traditional elastic components. It can achieve larger displacement vibration, effectively improving vibration performance and shock effect, avoiding the short service life caused by the fatigue of traditional elastic components, and improving the reliability of vibration motors.

The foregoing is merely illustrative of embodiments of the present invention, and it should be noted that modifications may be made to those skilled in the art without departing from the spirit of the invention but are intended to be within the scope of the invention.

What is claimed is:

1. A vibration motor comprising:
a housing with a containment space;
a vibration unit housed in the containment space, including at least two magnets arranged along a first direction with magnetization directions opposite to each other, and a coil component surrounding adjacent ends of the at least two magnets;
a driving unit for driving the vibration unit to reciprocate along the first direction;
a guide component supporting the vibration unit in the containment space;
two auxiliary magnet components fixed to the housing and respectively located at the two ends of the at least two magnets, each auxiliary magnet component being magnetized along a second direction perpendicular to the first direction, for forming magnetic repulsion with the corresponding at least two magnets.

2. The vibration motor as described in claim 1, wherein each auxiliary magnet component includes a pair of auxiliary magnets magnetized along the second direction and arranged on opposite sides of the vibration unit, for forming a magnetic repulsion with the corresponding at least two magnets; or each auxiliary magnet component includes two pairs of auxiliary magnets magnetized along the second direction and arranged on opposite sides of the vibration unit, for forming a magnetic repulsion with the corresponding at least two magnets; or each auxiliary magnet component is an annular magnet, with the second direction being the radial direction of the annular magnet, for forming a magnetic repulsion with the corresponding at least two magnet.

3. The vibration motor as described in claim 1, wherein the guiding member comprises two guiding sleeves arranged along the first direction at two ends of the vibration unit; the guiding sleeves include guiding passages therethrough; the vibration unit is accommodated in the guiding passage and slidably connected to the guiding sleeves.

4. The vibration motor as described in claim 3, wherein the vibration unit further includes a clamp plate located in the guiding sleeve and having a cavity; the magnet component is fixed with the clamp plate and accommodated in the cavity; and the clamp plate is slidably connected to the guiding sleeve.

5. The vibration motor as described in claim 4, wherein the guiding sleeve further includes an avoidance groove for avoiding the edge of the clamp plate.

6. The vibration motor as described in claim 4, wherein the magnet component further comprises a plurality of soft magnetic materials arranged at intervals along the first direction; an amount of the soft magnetic materials is 1 greater than an amount of the magnets; and the magnets are respectively disposed between two adjacent soft magnetic materials.

7. The vibration motor as described in claim 6, wherein the vibration unit further comprises weights disposed at two ends of the magnet component; the soft magnetic material includes a first soft magnetic material sandwiched between the weight and the magnet component, and a second soft magnetic material clamped between adjacent magnets; the auxiliary magnet component spaces apart from the first soft magnetic material; and the coil component spaces apart from the second soft magnetic material.

8. The vibration motor as described in claim 7, the weight includes a first part positioned outside the cavity and a second part accommodated inside the cavity; the first part does not contact the guiding sleeve, the clamp plate abuts against the first part; the second part includes a groove on a surface connected to the clamp plate, and the groove engages with a protrusion on the clamp plate.

9. The vibration motor as described in claim 6, wherein the soft magnetic material is made of at least one material selected from carbon steel, iron-cobalt alloy, amorphous alloy, and nanocrystalline alloys.
